(19) United States
(12) Patent Application Publication
(10) Pub. No.: US 2014/0010531 A1
(43) Pub. Date: Jan. 9, 2014

(54) SCHEDULING METHOD, APPARATUS, AND SYSTEM FOR AVOIDING DUAL-END MONITORING CONFLICT FOR SUBMARINE CABLE OPTICAL LINE

(71) Applicant: HUAWEI MARINE NETWORKS CO., LTD., Tianjin (CN)

(72) Inventors: Xiaobo HU, Shenzhen (CN); Yong ZHAO, Beijing (CN); Changwu XU, Beijing (CN); Bin LI, Xi'an (CN)

(73) Assignee: HUAWEI MARINE NETWORKS CO., LTD., Tianjin (CN)

(21) Appl. No.: 14/023,013

(22) Filed: Sep. 10, 2013

Related U.S. Application Data
(63) Continuation of application No. PCT/CN2012/072189, filed on Nov. 12, 2012.

(30) Foreign Application Priority Data
Mar. 11, 2011 (CN) 201110059179.4

(51) Int. Cl. H04B 10/079

(52) U.S. Cl. CPC H04B 10/079
USPC 398/25

(57) ABSTRACT

A scheduling method, apparatus, and system for avoiding a dual-end monitoring conflict for a submarine cable optical line are provided, where the method includes: sending a wavelength occupation request message to a peer-end equipment via a selected submarine cable optical line to be monitored, and receiving a wavelength occupation response message returned by the peer-end equipment; parsing the wavelength occupation response message to determine whether a requested wavelength is occupied by the peer-end equipment; and if the requested wavelength is occupied by the peer-end equipment and the wavelength can be switched, monitoring the selected submarine cable optical line to be monitored by using another wavelength after switching; and if the requested wavelength is not occupied by the peer-end equipment, monitoring the selected submarine cable optical line to be monitored by using the requested wavelength.

### CROSS-REFERENCE TO RELATED APPLICATIONS

This application is a continuation of International Application No. PCT/CN2012/072189, filed on Mar. 12, 2012, which claims priority to Chinese Patent Application No. 201110059179.4, filed on Mar. 11, 2011, both of which are hereby incorporated by reference in their entireties.

### FIELD OF THE INVENTION

Embodiments of the present invention relate to the field of communication technologies, and in particular, to a scheduling method, apparatus, and system for avoiding a dual-end monitoring conflict for a submarine cable optical line.

### BACKGROUND OF THE INVENTION

In the prior art, the optical line condition in a submarine cable is normally monitored by using a COTDR (Coherent Optical Time Domain Reflectometer, coherent optical time domain reflectometer) or OTDR (Optical Time Domain Reflectometer, optical time domain reflectometer) technology. The optical line condition needs to be monitored respectively in two directions for complete monitoring, and the case where a same optical wavelength is used simultaneously at both ends for monitoring needs to be avoided.

FIG. 1 is an example of a networking diagram for dual-end monitoring for submarine cable optical lines in the prior art. As shown in FIG. 1, in case of complex networking, because there are multiple end stations (where the end stations are mutually exclusive for occupying a same pair of optical fibers), one COTDR (or OTDR) equipment on every end station may need to monitor multiple optical fibers (where multiple optical fibers are mutually exclusive for monitoring inside an end station). Therefore, how to schedule the time sequence of the COTDR (or OTDR) monitoring equipment on every end station in the entire network for monitoring each optical fiber to avoid conflicts becomes a problem which must be considered.

A solution in the prior art is as follows: The monitoring time in each direction of every line is planned during network planning Every station obtains the monitoring time thereof respectively from a network management equipment 20, and performs monitoring according to the time. As shown in FIG. 1, in the prior art, the COTDR (or OTDR) equipment is implemented by using an LME (Line Monitoring Equipment, line monitoring equipment), and every pair of optical fibers is monitored by two LMEs. For example, an optical fiber 1 is monitored by an LME 1 and an LME 2 at different times. A user respectively configures a time for the LME 1 and the LME 2 to access the optical fiber 1; then, the LME 1 and the LME 2 start monitoring the optical fiber 1 at a specified time by using the time thereof as criteria. The method of the prior art for avoiding a wavelength conflict depends on a precondition that a peer-end equipment follows rules. A conflict may occur if the peer-end equipment does not follow the agreement. A conflict may easily occur if time of an end station is inaccurate. The method of the prior art cannot thoroughly avoid a wavelength conflict at the source and the reliability is low.

### SUMMARY OF THE INVENTION

Embodiments of the present invention provide a scheduling method, apparatus, and system for avoiding a dual-end monitoring conflict for a submarine cable optical line, which avoids a conflict by using communication and handshake between monitoring equipments.

In one aspect, embodiments of the present invention provide a scheduling method for avoiding a dual-end monitoring conflict for a submarine cable optical line, where the method includes: sending a wavelength occupation request message to a peer-end equipment via a selected submarine cable optical line to be monitored and receiving a wavelength occupation response message returned by the peer-end equipment; parsing the wavelength occupation response message to determine whether a requested wavelength is occupied by the peer-end equipment; and if the requested wavelength is occupied by the peer-end equipment and the wavelength can be switched, monitoring the selected submarine cable optical line to be monitored by using another wavelength after switching, and if the requested wavelength is not occupied by the peer-end equipment, monitoring the selected submarine cable optical line to be monitored by using the requested wavelength.

In another aspect, embodiments of the present invention further provide a scheduling apparatus for avoiding a dual-end monitoring conflict for a submarine cable optical line, where the apparatus includes: a communication unit configured to send a wavelength occupation request message to a peer-end equipment via a selected submarine cable optical line to be monitored and receive a wavelength occupation response message returned by the peer-end equipment; a command parsing unit, configured to parse the wavelength occupation response message to determine whether a requested wavelength is occupied by the peer-end equipment; and a monitoring management unit, configured to: when the requested wavelength is occupied by the peer-end equipment and the wavelength can be switched, monitor the selected submarine cable optical line to be monitored by using another wavelength after switching, and when the requested wavelength is not occupied by the peer-end equipment, monitor the selected submarine cable optical line to be monitored by using the requested wavelength.

In still another aspect, embodiments of the present invention further provide a scheduling system for avoiding a dual-end monitoring conflict for a submarine cable optical line, where the system includes monitoring equipments connected to multiple submarine cable optical lines to be monitored at two ends, and a network management equipment connected to the monitoring equipments. The monitoring equipment is configured to: send a wavelength occupation request message to a peer-end equipment via a selected submarine cable optical line to be monitored and receive a wavelength occupation response message returned by the peer-end equipment; parse the wavelength occupation response message to determine whether a requested wavelength is occupied by the peer-end equipment; if the requested wavelength is occupied by the peer-end equipment and the wavelength can be switched, monitor the selected submarine cable optical line to be monitored by using another wavelength after switching; and if the requested wavelength is not occupied by the peer-end equipment, monitor the selected submarine cable optical line to be monitored by using the requested wavelength. The network management equipment is configured to deliver configuration information to the monitoring equipment, where the configuration information at least includes a communication address of the peer-end equipment corresponding to the monitoring equipment.

The beneficial effect of the present invention lies in that, the technical solutions according to embodiments of the present invention avoid conflicts by using communication and handshake between monitoring equipments, which improves monitoring efficiency; and a monitoring equipment added during expansion of a submarine cable network may also be conveniently added to an existing monitoring task, thereby enabling flexible and easy expansion.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following descriptions show merely some embodiments of the present invention, and persons of ordinary skill in the art may still derive other drawings from the accompanying drawings without creative efforts.

FIG. 1 is an example of a networking diagram for dual-end monitoring for submarine cable optical lines in the prior art;

FIG. 2 is an overall flowchart of a scheduling method for avoiding a dual-end monitoring conflict for a submarine cable optical line according to an embodiment of the present invention;

FIG. 3 is a detailed flowchart of a scheduling method for avoiding a dual-end monitoring conflict for a submarine cable optical line according to an embodiment of the present invention;

FIG. 4 is a functional block diagram of a scheduling apparatus for avoiding a dual-end monitoring conflict for a submarine cable optical line according to an embodiment of the present invention; and

FIG. 5 is a schematic diagram of a scheduling system for avoiding a dual-end monitoring conflict for a submarine cable optical line according to an embodiment of the present invention.

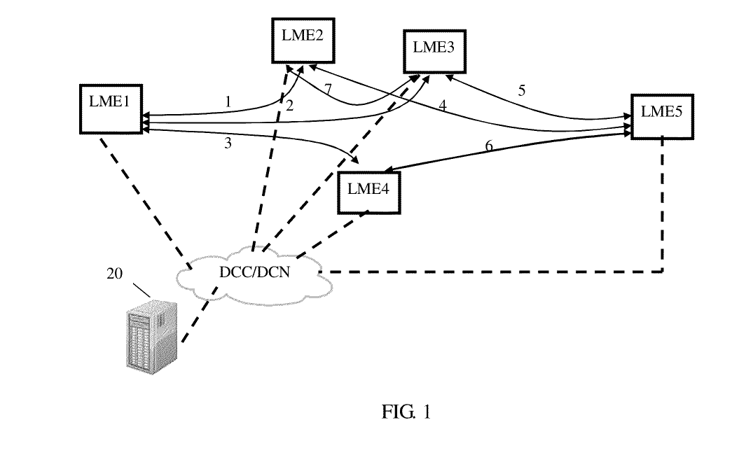

### DETAILED DESCRIPTION OF THE EMBODIMENTS

Embodiments of the present invention provide a scheduling method, apparatus, and system for avoiding a dual-end monitoring conflict for a submarine cable optical line to solve the problem of monitoring wavelength conflicts when a COTDR (or OTDR) equipment is used for optical line monitoring. The solutions, by using communication and handshake between COTDR (or OTDR) equipments, are capable of checking and avoiding a monitoring conflict efficiently and independently, and all monitoring equipments in the entire network may select and schedule a line to be monitored by themselves. The COTDR (or OTDR) equipment will be exemplified by using an LME in the following embodiments of the present invention.

To make the objectives, technical solutions, and advantages of embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

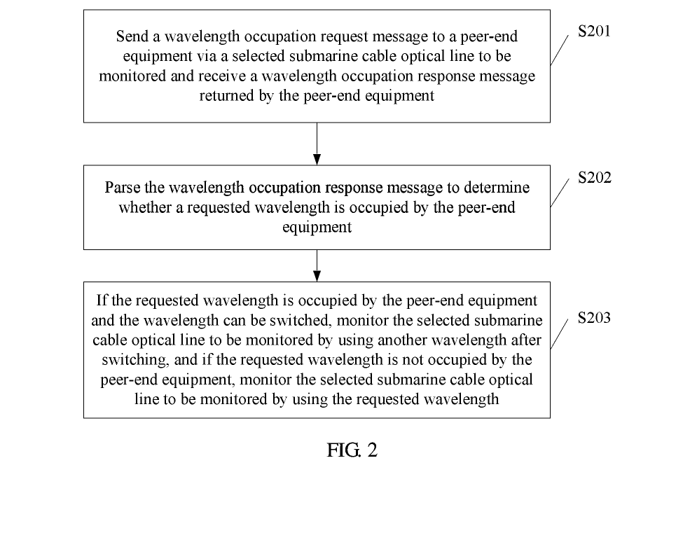

First, embodiments of the present invention provide a scheduling method for avoiding a dual-end monitoring conflict for a submarine cable optical line. FIG. 2 is an overall flowchart of the method. As shown in FIG. 2, the method includes:

S201. sending a wavelength occupation request message to a peer-end equipment via a selected submarine cable optical line to be monitored and receiving a wavelength occupation response message returned by the peer-end equipment;

S202. parsing the wavelength occupation response message to determine whether a requested wavelength is occupied by the peer-end equipment; and

S203. if the requested wavelength is occupied by the peer-end equipment and the wavelength can be switched, monitoring the selected submarine cable optical line to be monitored by using another wavelength after switching, and if the requested wavelength is not occupied by the peer-end equipment, monitoring the selected submarine cable optical line to be monitored by using the requested wavelength.

Optionally, the method further includes: if the requested wavelength is occupied by the peer-end equipment, and the wavelength cannot be switched, but there is another submarine cable optical line to be monitored, reselecting a submarine cable optical line to be monitored, and sending the wavelength occupation request message to the peer-end equipment via the reselected submarine cable optical line to be monitored.

Optionally, the method further includes: if the requested wavelength is occupied by the peer end equipment, and the wavelength cannot be switched, and there is no other submarine cable optical line to be monitored, waiting for a period of time t randomly and resending the wavelength occupation request message to the peer-end equipment.

Optionally, the method further includes: receiving configuration information from a network management equipment and obtaining a communication address of the peer-end equipment. The communication between a local-end equipment and the peer-end equipment in the steps shown in FIG. 2 may be implemented by obtaining the communication address of the peer-end equipment. Certainly, the communication address of the peer-end equipment may also be configured on the local-end equipment in advance, and in such cases, does not need to be obtained from the network management equipment every time.

Optionally, the method further includes: presetting a monitoring period, and initiating monitoring for a submarine cable optical line according to the monitoring period.

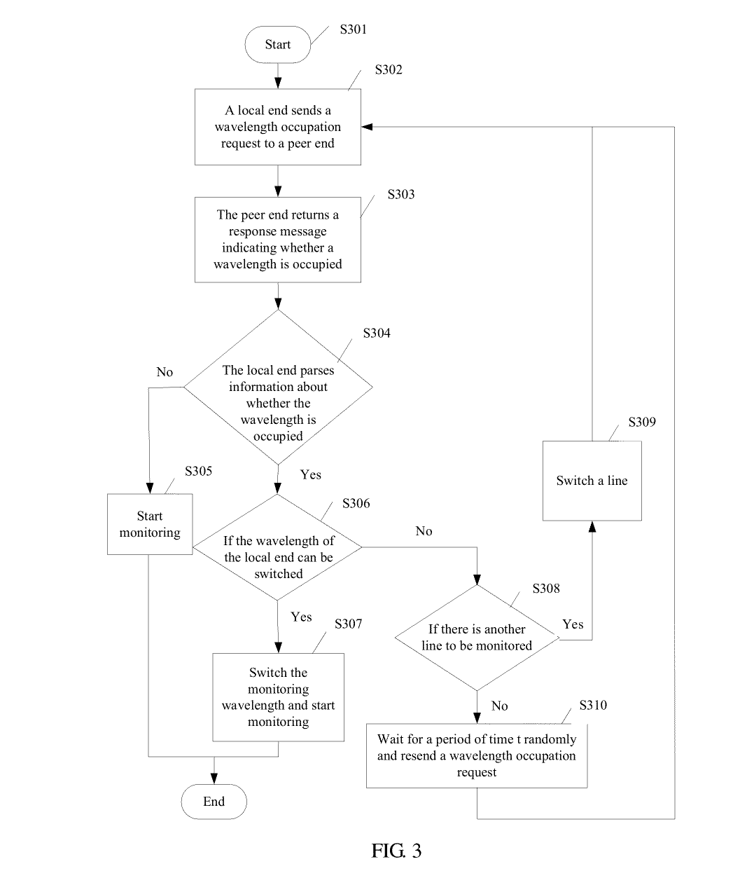

FIG. 3 is a detailed flowchart of a scheduling method for avoiding a dual-end monitoring conflict for a submarine cable optical line according to an embodiment of the present invention. As shown in FIG. 3, the method includes:

S301. completing, by a monitoring equipment, communication between monitoring equipments by using a DCN (Data Communication Network, data communication network) or in-band communication between LMEs at two ends of an optical line to be monitored, where the monitoring equipment is managed by a network management system; and delivering, by the network management system, a command for starting monitoring to a local-end equipment;

S302. after receiving the command, sending, by the local-end equipment, a request for occupying an optical line by using a specific wavelength to a peer-end equipment based on a communication solution in S301;

S303. checking, by the peer-end equipment, after receiving the request of the local-end equipment, the availability of optical lines thereof, and returning a response to the local-end equipment;

S304. after receiving the response, parsing, by the local-end equipment, the response to obtain information about whether the wavelength is occupied by the peer-end equipment;

S305. if the wavelength is not occupied, monitoring the optical line by using the wavelength;

S306. if the wavelength is occupied, further determining whether the wavelength of the local end equipment can be switched;

S307. if the wavelength of the local-end equipment can be switched, changing the monitoring wavelength for monitoring;

S308. if only one wavelength is available, continuing to determine whether there is another line to be monitored;

S309. if there is another line to be monitored, selecting another line and returning to S302 for monitoring the other line; and

S310. if it is known by parsing in S304 that the wavelength is occupied, and the local-end equipment has only one available wavelength, and there is no other optional line to be monitored, waiting for a random period of t and re-initiating a request to the peer-end equipment.

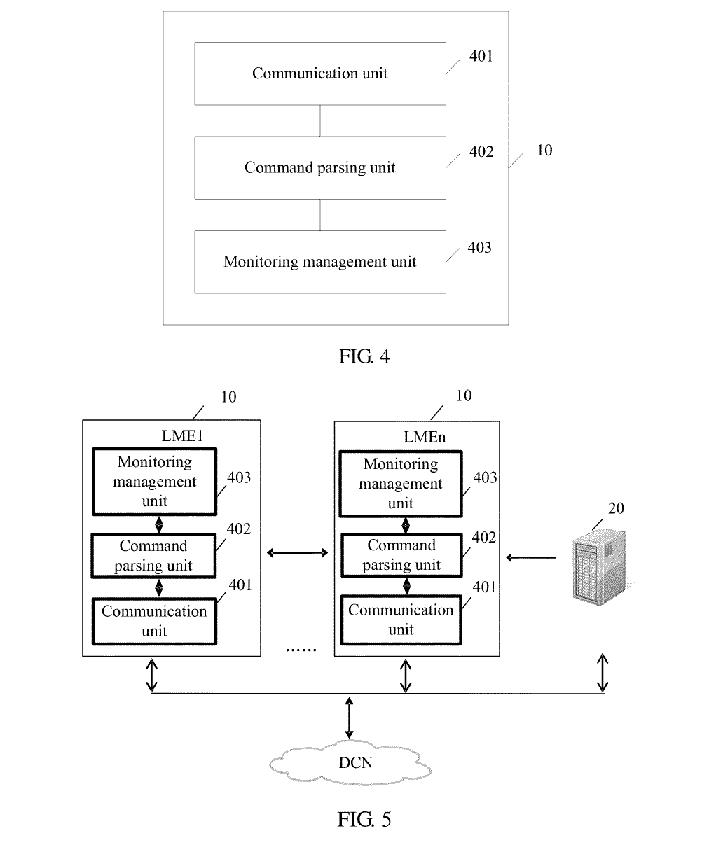

Corresponding to the method according to the above embodiment, a scheduling apparatus for avoiding a dual-end monitoring conflict for a submarine cable optical line is further provided by this embodiment. FIG. 4 is a functional block diagram of the apparatus 10. As shown in FIG. 4, the apparatus 10 includes a communication unit 401, configured to send a wavelength occupation request message to a peer-end equipment via a selected submarine cable optical line to be monitored and receive a wavelength occupation response message returned by the peer-end equipment; a command parsing unit 402, configured to parse the wavelength occupation response message to determine whether a requested wavelength is occupied by the peer-end equipment; and a monitoring management unit 403, configured to: when the requested wavelength is occupied by the peer-end equipment and the wavelength can be switched, monitor the selected submarine cable optical line to be monitored by using another wavelength after switching, and when the requested wavelength is not occupied by the peer-end equipment, monitor the selected submarine cable optical line to be monitored by using the requested wavelength.

Optionally, the monitoring management unit 403 is further configured to: when the requested wavelength is occupied by the peer-end equipment, and the wavelength cannot be switched, but there is another submarine cable optical line to be monitored, reselect a submarine cable optical line to be monitored, and send the wavelength occupation request message to the peer-end equipment via the reselected submarine cable optical line to be monitored.

Optionally, the monitoring management unit 403 is further configured to: when the requested wavelength is occupied by the peer end equipment, and the wavelength cannot be switched, and there is no other submarine cable optical line to be monitored, wait for a period of time t randomly and resend the wavelength occupation request message to the peer-end equipment.

Corresponding to the method and the apparatus according to the above embodiments, a scheduling system for avoiding a dual-end monitoring conflict for a submarine cable optical line is further provided by an embodiment of the present invention. FIG. 5 is a schematic diagram of the system. As shown in FIG. 5, the system includes a monitoring equipments 10 connected to multiple submarine cable optical lines to be monitored at two ends, and a network management equipment 20 connected to the monitoring equipments.

The monitoring equipment 10 is configured to: send a wavelength occupation request message to a peer-end equipment via a selected submarine cable optical line to be monitored, and receive a wavelength occupation response message returned by the peer-end equipment; parse the wavelength occupation response message to determine whether a requested wavelength is occupied by the peer-end equipment; if the requested wavelength is occupied by the peer-end equipment and the wavelength can be switched, monitor the selected submarine cable optical line to be monitored by using another wavelength after switching; and if the requested wavelength is not occupied by the peer-end equipment, monitor the selected submarine cable optical line to be monitored by using the requested wavelength.

The network management equipment 20 is configured to deliver configuration information to the monitoring equipment, where the configuration information at least includes a communication address of the peer-end equipment corresponding to the monitoring equipment.

Optionally, the monitoring equipment 10 is further configured to: when the requested wavelength is occupied by the peer-end equipment, and the wavelength cannot be switched, but there is another submarine cable optical line to be monitored, reselect a submarine cable optical line to be monitored, and send the wavelength occupation request message to the peer-end equipment via the reselected submarine cable optical line to be monitored.

Optionally, the monitoring equipment 10 is further configured to: when the requested wavelength is occupied by the peer end equipment, and the wavelength cannot be switched, and there is no other submarine cable optical line to be monitored, wait for a period of time t randomly and resend the wavelength occupation request message to the peer-end equipment.

Optionally, a communication network of the system includes an in-band communication network between monitoring equipments or a data communication network DCN; or one of the in-band communication network and the DCN is used as a primary communication network, and the other one is used as a standby communication network.

As shown in FIG. 5, the specific operating principle of the system is as follows: An NMS controls and manages all equipments on the network; LMEs monitor optical fibers, and interact by using a DCN network. When a user needs to start optical fiber monitoring by using an LME, the NMS configures information about an optical line to be monitored by the LME for the LME, and then delivers a communication address of an equipment at a peer end equipment of the LME to the LME, thereby starting monitoring; then the NMS may be hosted and does not need to control every LME in real time. In the LME, a DCN communication unit is responsible for communication between equipments; a command parsing unit is responsible for parsing commands in communication between the equipments, and a monitoring management unit is responsible for processing conflict monitoring logic.

In the technical solutions of the present invention, monitoring equipments at two ends negotiate by themselves about monitoring wavelength conflicts; in a case where there is a dual-end wavelength conflict, the sequence for line monitoring may be adjusted, thereby making the best of an idle optical line and shortening the overall monitoring time. In a case where there is a dual-end wavelength conflict and the local-end wavelength can be switched, the monitoring wavelength at the local end may be negotiated and selected, thereby avoiding conflicts.

By using the technical features described above, the technical solutions according to embodiments of the present invention are capable of obtaining the following technical benefits.

Benefit 1: The network management system, after configuring monitoring periods for every monitoring equipment, uniformly starts periodic monitoring of all monitoring equipments, does not need to schedule the sequence for the monitoring equipments to occupy optical lines after startup, where the sequence is implemented by negotiation between the monitoring equipments, and does not require the network management system for avoiding conflicts. The monitoring equipments are not affected if the network management system is offline, and therefore are highly reliable.

Benefit 2: Optical lines on a network may be monitored in parallel to the maximum. For monitoring of an entire network, compared with an existing solution where the network management system uniformly assigns monitoring time slices to all equipments and the equipments are ensured to perform monitoring only in specified periods, the technical solutions of the present invention use less time and improve the efficiency.

Benefit 3: In this solution, conflict monitoring entirely depends on a protocol negotiation mechanism between equipments, and a monitoring equipment added during expansion of the submarine cable network may also be conveniently added to an existing monitoring task, thereby enabling flexible and easy expansion.

Persons of ordinary skill in the art may understand that all or a part of the processes of the methods in the embodiments may be implemented by a computer program instructing relevant hardware. The program may be stored in a computer readable storage medium. When the program is run, the processes of the methods in the embodiments are performed. The storage medium may be a magnetic disk, an optical disk, a Read-Only Memory (Read-Only Memory, ROM), or a Random Access Memory (Read-Only Memory, RAM), and the like.

The foregoing embodiments are merely intended for describing the technical solutions of the embodiments of the present invention other than limiting the present invention. Although the embodiments of the present invention are described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A scheduling method for avoiding a dual-end monitoring conflict for a submarine cable optical line, comprising:
sending a wavelength occupation request message to a peer-end equipment via a selected submarine cable optical line to be monitored and receiving a wavelength occupation response message returned by the peer-end equipment;
parsing the wavelength occupation response message to determine whether a requested wavelength is occupied by the peer-end equipment; and
if the requested wavelength is occupied by the peer-end equipment and the wavelength can be switched, monitoring the selected submarine cable optical line to be monitored by using another wavelength after switching, and if the requested wavelength is not occupied by the peer-end equipment, monitoring the selected submarine cable optical line to be monitored by using the requested wavelength.

2. The method according to claim 1, wherein the method further comprises:
if the requested wavelength is occupied by the peer-end equipment, and the wavelength cannot be switched, but there is another submarine cable optical line to be monitored, reselecting a submarine cable optical line to be monitored, and sending the wavelength occupation request message to the peer-end equipment via the reselected submarine cable optical line to be monitored.

3. The method according to claim 1, wherein the method further comprises:
if the requested wavelength is occupied by the peer end equipment, and the wavelength cannot be switched, and there is no other submarine cable optical line to be monitored, waiting for a period of time t randomly and resending the wavelength occupation request message to the peer-end equipment.

4. The method according to claim 1, wherein the method further comprises:
receiving configuration information from a network management equipment, and obtaining a communication address of the peer-end equipment.

5. The method according to claim 1, wherein the method further comprises:
presetting a monitoring period, and initiating monitoring for a submarine cable optical line according to the monitoring period.

6. A scheduling apparatus for avoiding a dual-end monitoring conflict for a submarine cable optical line, comprising:
a communication unit, configured to send a wavelength occupation request message to a peer-end equipment via a selected submarine cable optical line to be monitored and receive a wavelength occupation response message returned by the peer-end equipment;
a command parsing unit, configured to parse the wavelength occupation response message to determine whether a requested wavelength is occupied by the peer-end equipment; and
a monitoring management unit, configured to: when the requested wavelength is occupied by the peer-end equipment and the wavelength can be switched, monitor the selected submarine cable optical line to be monitored by using another wavelength after switching, and when the requested wavelength is not occupied by the peer-end equipment, monitor the selected submarine cable optical line to be monitored by using the requested wavelength.

7. The apparatus according to claim 6, wherein:
the monitoring management unit is further configured to: when the requested wavelength is occupied by the peer-end equipment, and the wavelength cannot be switched, but there is another submarine cable optical line to be monitored, reselect a submarine cable optical line to be monitored, and send the wavelength occupation request message to the peer-end equipment via the reselected submarine cable optical line to be monitored.

8. The apparatus according to claim 6, wherein:
the monitoring management unit is further configured to: when the requested wavelength is occupied by the peer end equipment, and the wavelength cannot be switched, and there is no other submarine cable optical line to be monitored, wait for a period of time t randomly and resend the wavelength occupation request message to the peer-end equipment.

9. A scheduling system for avoiding a dual-end monitoring conflict for a submarine cable optical line, wherein the system comprises monitoring equipments connected to multiple submarine cable optical lines at two ends, and a network management equipment connected to the monitoring equipments;
the monitoring equipment is configured to: send a wavelength occupation request message to a peer-end equipment via a selected submarine cable optical line to be monitored, and receive a wavelength occupation response message returned by the peer-end equipment; parse the wavelength occupation response message to determine whether a requested wavelength is occupied by the peer-end equipment; if the requested wavelength is occupied by the peer-end equipment and the wavelength can be switched, monitor the selected submarine cable optical line to be monitored by using another wavelength after switching; and if the requested wavelength is not occupied by the peer-end equipment, monitor the selected submarine cable optical line to be monitored by using the requested wavelength; and
the network management equipment is configured to deliver configuration information to the monitoring equipment, wherein the configuration information at least comprises a communication address of the peer-end equipment corresponding to the monitoring equipment.

10. The system according to claim 9, wherein:
the monitoring equipment is further configured to: when the requested wavelength is occupied by the peer-end equipment, and the wavelength cannot be switched, but there is another submarine cable optical line to be monitored, reselect a submarine cable optical line to be monitored, and send the wavelength occupation request message to the peer-end equipment via the reselected submarine cable optical line to be monitored.

11. The system according to claim 9, wherein:
the monitoring equipment is further configured to: when the requested wavelength is occupied by the peer end equipment, and the wavelength cannot be switched, and there is no other submarine cable optical line to be monitored, wait for a period of time t randomly and resend the wavelength occupation request message to the peer-end equipment.

12. The system according to claim 9, wherein a communication network of the system comprises an in-band communication network between monitoring equipments or a data communication network DCN; or one of the in-band communication network and the DCN is used as a primary communication network, and the other one is used as a standby communication network.
